(19) United States
(12) Patent Application Publication
(10) Pub. No.: US 2014/0131414 A1
(43) Pub. Date: May 15, 2014

(54) NAILING SYSTEM AND METHOD

(71) Applicants: Ricardo M. Garcia, Orlando, FL (US); Christopher J. Gerou, Orlando, FL (US); James E. Mabe, JR., Orlando, FL (US)

(72) Inventors: Ricardo M. Garcia, Orlando, FL (US); Christopher J. Gerou, Orlando, FL (US); James E. Mabe, JR., Orlando, FL (US)

(73) Assignee: CHEP Technology Pty Limited, Sydney (AU)

(21) Appl. No.: 13/673,930

(22) Filed: Nov. 9, 2012

(51) Int. Cl. B25C 7/00

(52) U.S. Cl. CPC B25C 7/00
USPC 227/61; 29/428; 29/426.2

(57) ABSTRACT

A nailing system may include a bracket that mounts to a nail gun, and an arm. The system may also include a movable joint to connect the arm to the bracket. The system may further include an anvil carried by the arm where the arm positions the anvil to be under a driver of the nail gun, and the anvil bends nails driven by the driver.

### BACKGROUND

The invention relates to the field of fasteners, and, more particularly, to nailing systems.

Generally, a shipping platform, e.g. pallet, is fabricated out of top deck members joined to blocks, which are joined to bottom deck members. The top deck members, the blocks, and/or the bottom deck members comprise wood, metal, plastic, composite materials, and/or the like.

The top deck members, the blocks, and/or the bottom deck members are usually joined utilizing fasteners such as nails, screws, dowels, and/or the like for their joinery. This enables the top deck members, the blocks, and/or the bottom deck members of the shipping platform to be assembled and/or repaired as needed.

### SUMMARY

According to one embodiment, a fastening system may include a bracket that mounts to a nail gun, and an arm. The system may also include a movable joint to connect the arm to the bracket. The system may further include an anvil carried by the arm where the arm positions the anvil to be under a driver of the nail gun, and the anvil bends nails driven by the driver.

The movable joint may be resiliently deformable and urges the arm towards the bracket. The movable joint may comprise a hinge.

The movable joint may rotate around a pin. The anvil may include a shaped strike portion positioned under the driver to aid in bending the nails driven by the nail gun.

The system may additionally include a biasing member to urge the arm towards the bracket. The system may also include a stop that keeps the bracket and the arm in spaced relations.

The stop may be adjustable. The anvil may include an eased edge. The system may further include a lever to move the arm with respect to the bracket via the movable joint.

Another aspect of the embodiments is a method for nailing. The method may include mounting a bracket carrying an arm to a nail gun. The method may also include positioning an anvil carried by the arm to be under a driver of the nail gun so that the anvil bends nails driven by the driver.

The method may also include using a biasing member to urge the arm towards the bracket. The method may further include controlling the spacing between the arm and the bracket with a stop.

The method may additionally include using a lever to adjust the arm with respect to the bracket. The method may also comprise including a shaped strike portion on the anvil positioned under the driver to aid in bending the nails driven by the nail gun. The method may further include removing a pin to separate the arm from the bracket.

An alternative embodiment of the fastening system may include a bracket that mounts to a nail gun, and an arm. The system may also include a hinge to connect the arm to the bracket. The system may further include an anvil carried by the arm where the arm positions the anvil to be under a driver of the nail gun, and the anvil bends nails driven by the driver. The system may additionally include a first biasing member to urge the arm towards the bracket.

### BRIEF DESCRIPTION OF THE DRAWINGS

FIG. 1 is a side view of a nailing system in accordance with the invention.

FIG. 2 is a side view of the nailing system of FIG. 1 mounted on a nail gun.

FIG. 3 is rear side view of an alternative embodiment of the nailing system in its usage position.

FIG. 4 is a top side view of a clenched nail provided by the nailing system of FIG. 1.

FIG. 5 is top side view of an alternative embodiment of the nailing system with a shaped strike portion.

FIG. 6 is a flowchart illustrating method aspects according to the invention.

FIG. 7 is a flowchart illustrating method aspects according to the method of FIG. 6.

FIG. 8 is a flowchart illustrating method aspects according to the method of FIG. 7.

FIG. 9 is a flowchart illustrating method aspects according to the method of FIG. 7.

FIG. 10 is a flowchart illustrating method aspects according to the method of FIG. 6.

FIG. 11 is a flowchart illustrating method aspects according to the method of FIG. 6.

### DETAILED DESCRIPTION

Embodiments will now be described more fully hereinafter with reference to the accompanying drawings, in which preferred embodiments of the invention are shown. Like numbers refer to like elements throughout.

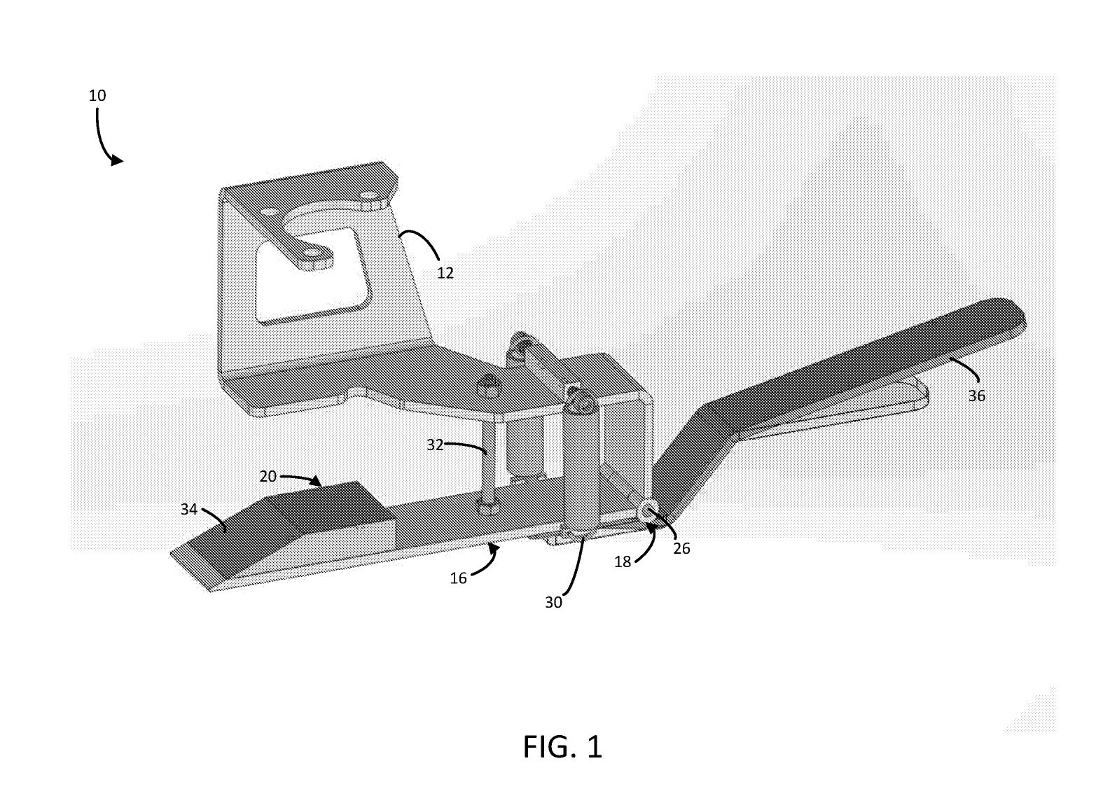

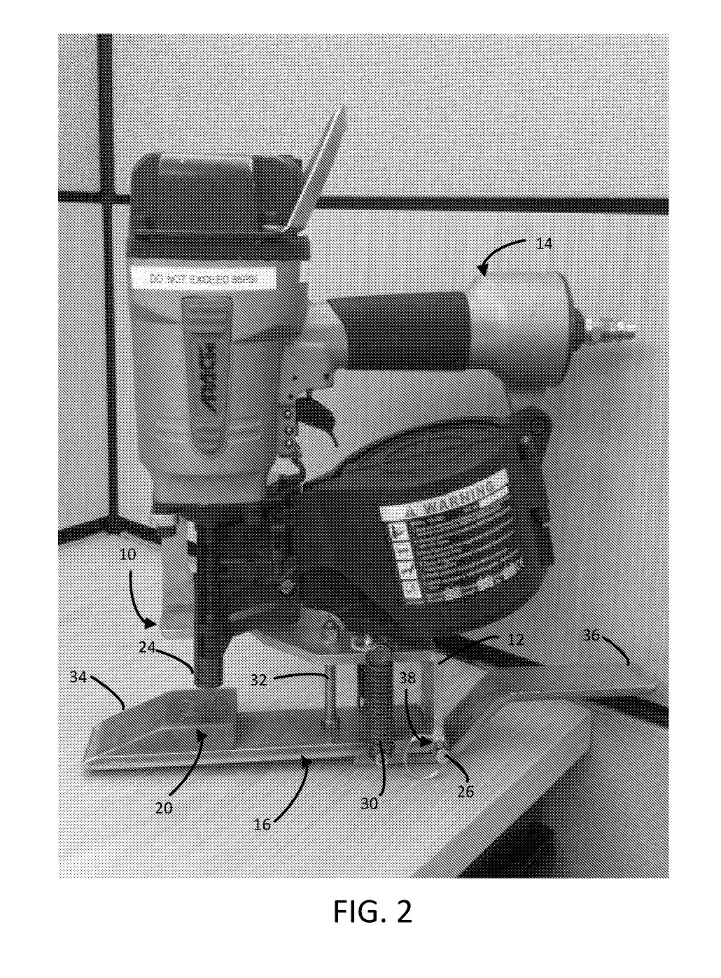

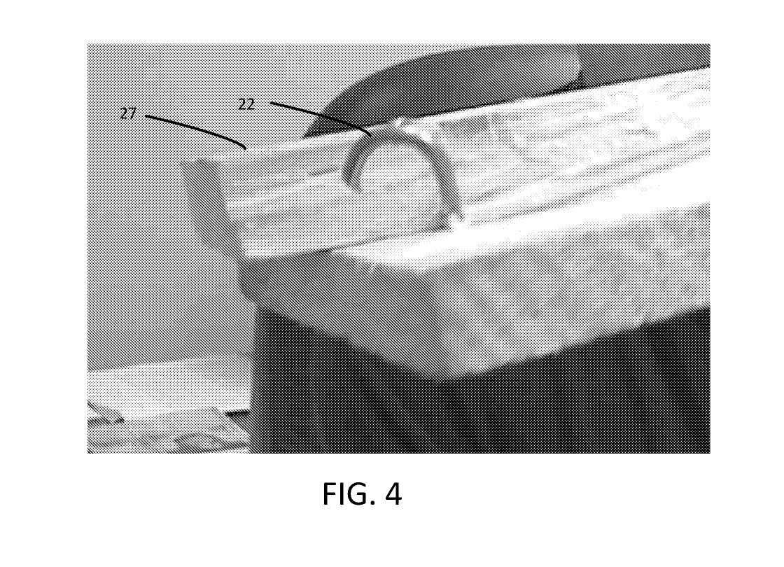

With reference now to FIGS. 1-4, a fastening system 10 is initially described. According to one embodiment, the system 10 includes a bracket 12 and an arm 16. The bracket 12 mounts the system 10 to a nail gun 14. The nail gun 14 may be pneumatically actuated, electrically actuated, hydraulically actuated, combustion actuated, and/or the like. The system 10 also includes a movable joint 18 to connect the arm 16 to the bracket 12. The system 10 further includes an anvil 20 carried by the arm 16 where the arm positions the anvil to be under a driver (not shown) of the nail gun 14, and the anvil bends nails 22 driven by the driver (see FIG. 4). The driver is housed within bore 24 of the nail gun 14 and therefore cannot be seen in the figures.

In one embodiment, the movable joint 20 is resiliently deformable and urges the arm towards the bracket. In another embodiment, the movable joint 20 comprises a hinge 38.

In one embodiment, the movable joint 20 rotates around a pin 26. In another embodiment, the pin 26 is removable.

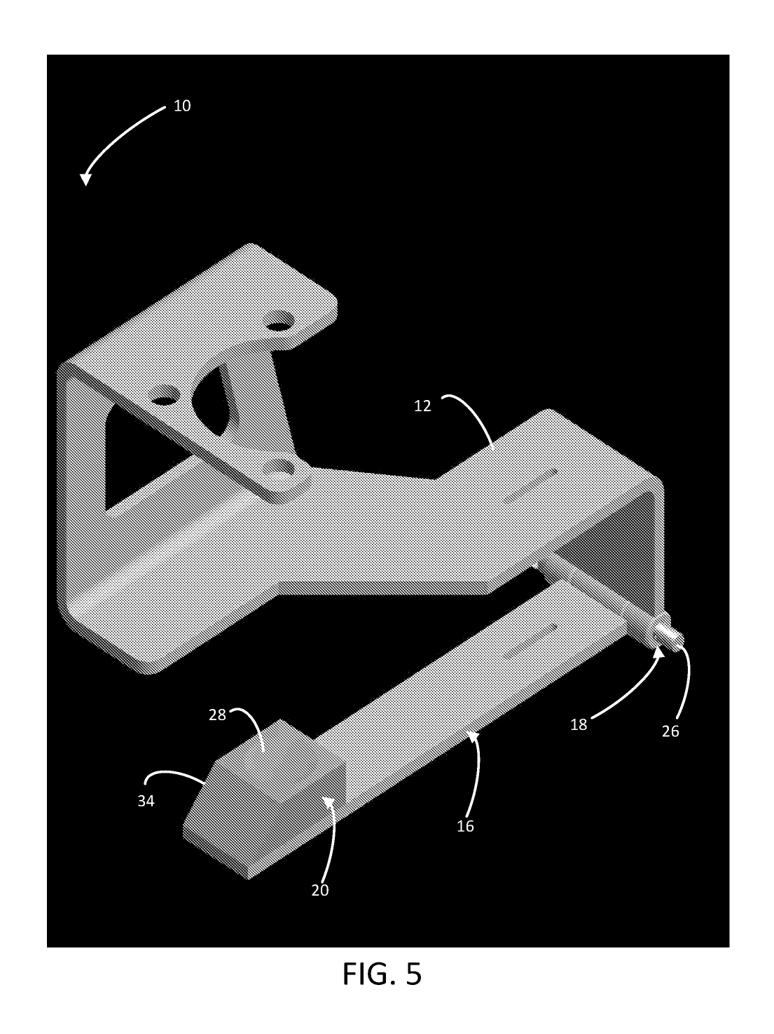

With further reference to FIG. 5, in one embodiment, the anvil 20 includes a shaped strike portion 28 positioned under the driver to aid in bending the nails 22 driven by the nail gun 14. For example, the shaped strike portion 28 may be a protuberance, depression, and/or the like that compels the nail's 22 point to move in a desired direction.

In one embodiment, the system 10 additionally includes a biasing member 30 to urge the arm 16 towards the bracket 12. In another embodiment, the system 10 also includes a stop 32 that keeps the bracket 12 and the arm 16 in spaced relations. In other words, the stop 32 physically sets the spacing between the bracket 12 and the arm 16.

In one embodiment, the stop 32 is adjustable. In another embodiment, the anvil 20 includes an eased edge 34. Stated another way, two of the anvil's 20 sides do not meet at a right angle to each other. For instance, the eased edge 34 may be a bullnose, chamfer, bevel, and/or the like that makes use of the system 10 by a user easier.

In one embodiment, the system 10 further includes a lever 36 to move the arm 16 with respect to the bracket 12 via the movable joint 20. In other words, the lever 36 makes use of the system 10 by a user easier.

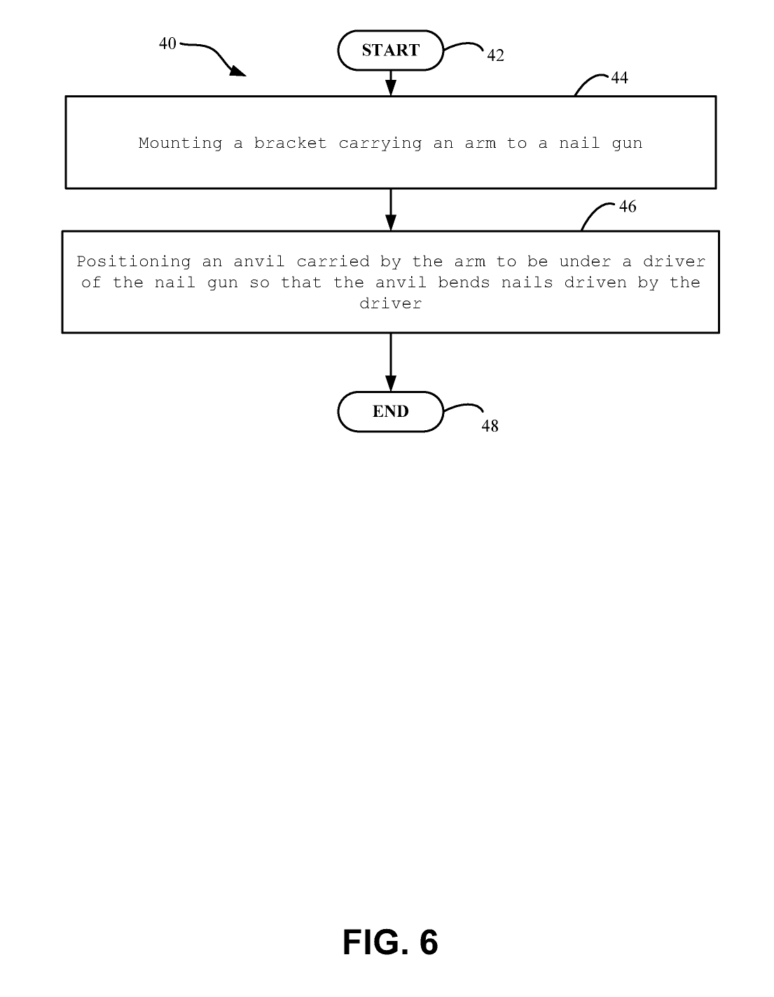

Another aspect of the invention is a method for nailing, which is now described with reference to flowchart 40 of FIG. 6. The method begins at Block 42 and may include mounting a bracket carrying an arm to a nail gun at Block 44. The method may also include positioning an anvil carried by the arm to be under a driver of the nail gun so that the anvil bends nails driven by the driver at Block 46. The method ends at Block 48.

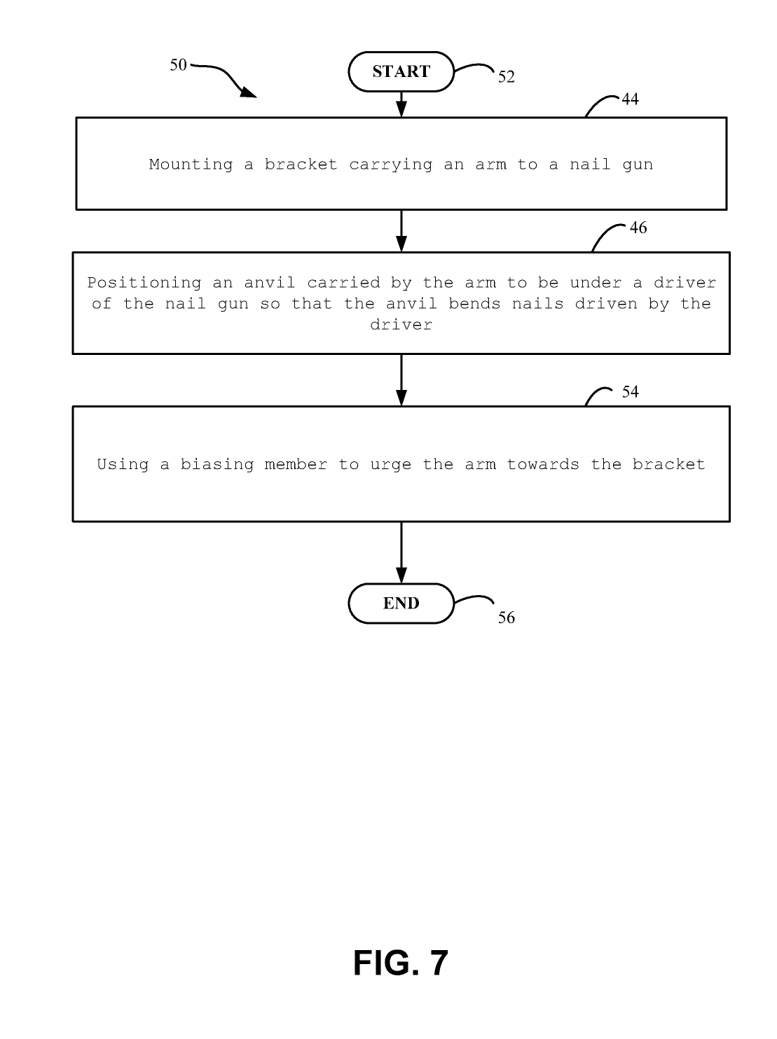

In another method embodiment, which is now described with reference to flowchart 50 of FIG. 7, the method begins at Block 52. The method may include the steps of FIG. 6 at Blocks 44 and 46. The method may additionally include using a biasing member to urge the arm towards the bracket at Block 54. The method ends at Block 56.

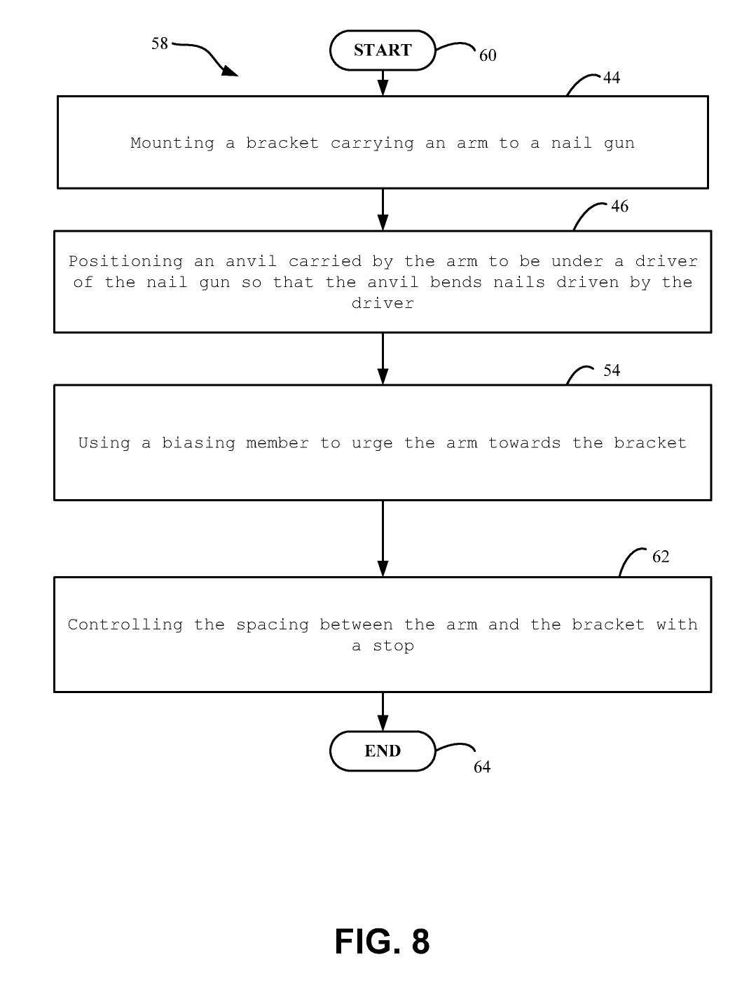

In another method embodiment, which is now described with reference to flowchart 58 of FIG. 8, the method begins at Block 60. The method may include the steps of FIG. 7 at Blocks 44, 46, and 54. The method may further include controlling the spacing between the arm and the bracket with a stop at Block 62. The method ends at Block 64.

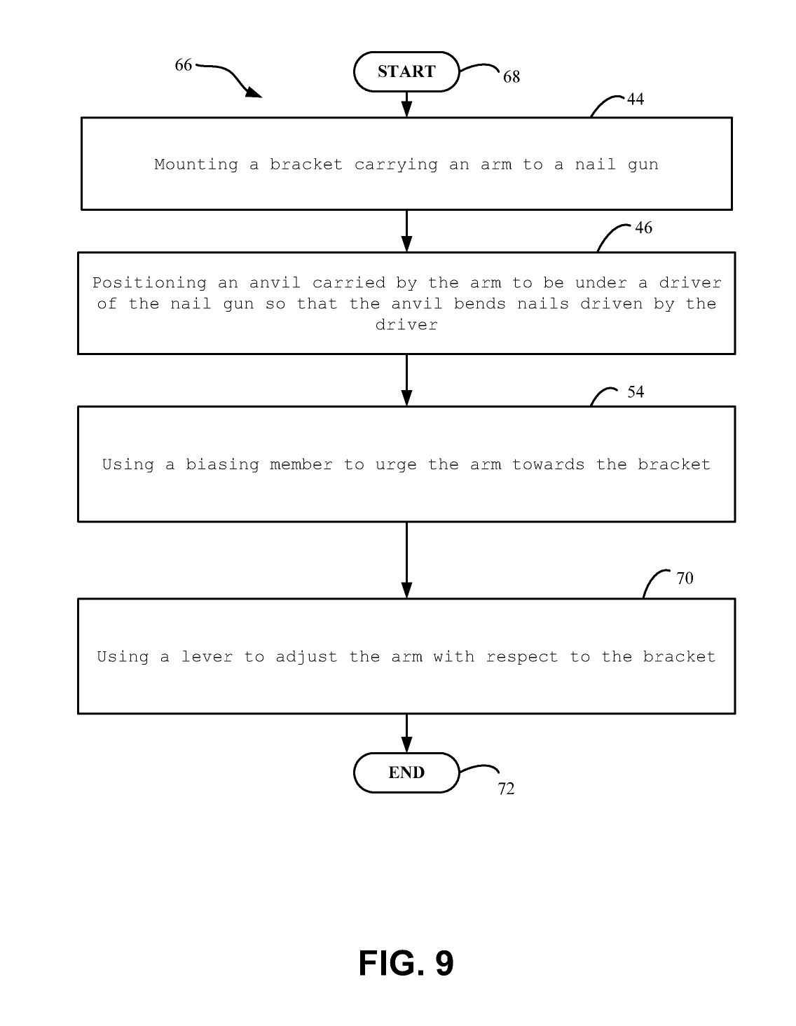

In another method embodiment, which is now described with reference to flowchart 66 of FIG. 9, the method begins at Block 68. The method may include the steps of FIG. 7 at Blocks 44, 46, and 54. The method may further include using a lever to adjust the arm with respect to the bracket at Block 70. The method ends at Block 72.

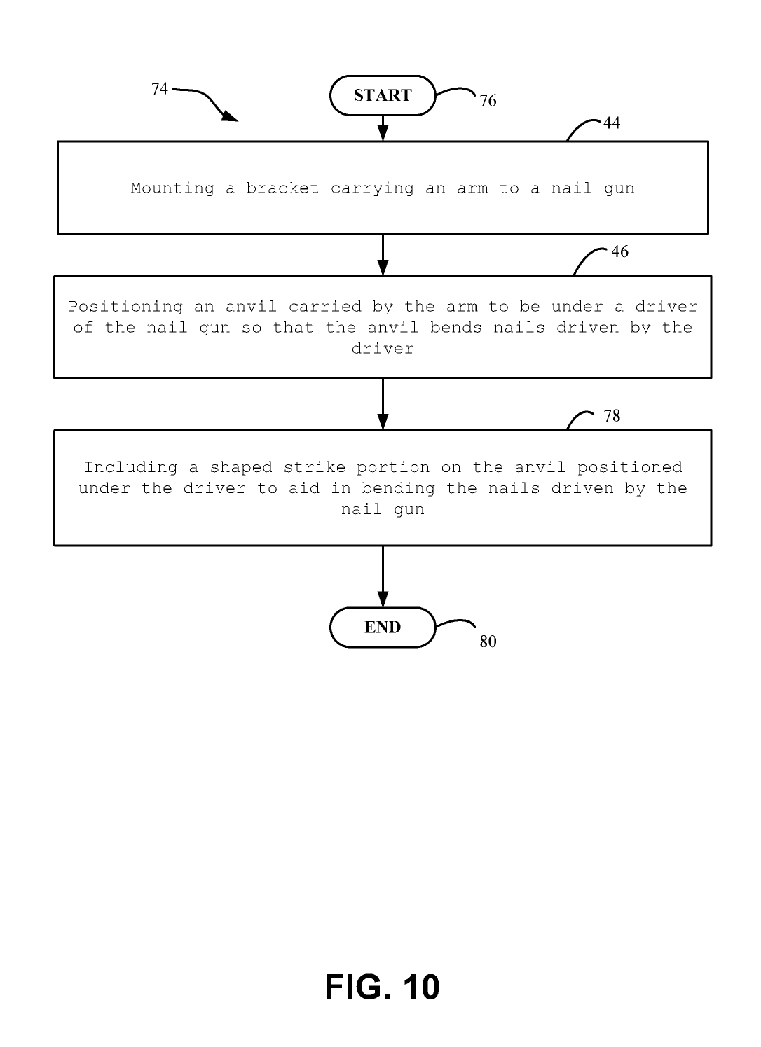

In another method embodiment, which is now described with reference to flowchart 74 of FIG. 10, the method begins at Block 76. The method may include the steps of FIG. 6 at Blocks 44 and 46. The method may additionally comprise including a shaped strike portion on the anvil positioned under the driver to aid in bending the nails driven by the nail gun at Block 78. The method ends at Block 80.

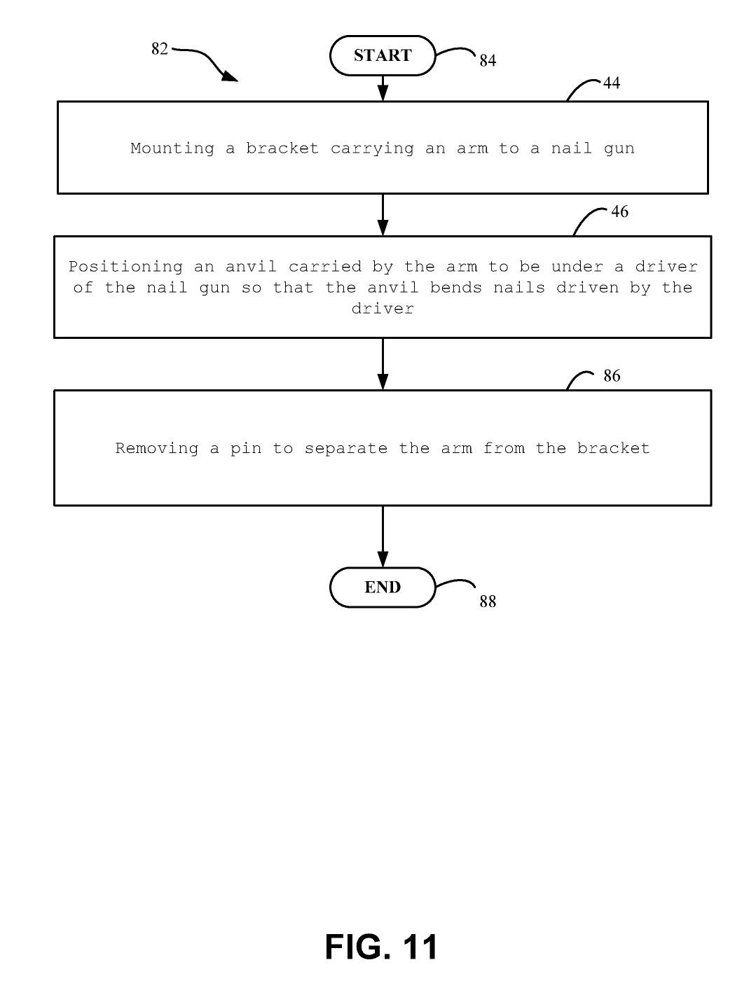

In another method embodiment, which is now described with reference to flowchart 82 of FIG. 11, the method begins at Block 84. The method may include the steps of FIG. 6 at Blocks 44 and 46. The method may additionally include removing a pin to separate the arm from the bracket at Block 86. The method ends at Block 88.

An alternative fastening system 10 includes a bracket 12 and an arm 16 that mounts to a nail gun 14. The system 10 also includes a hinge 38 to connect the arm 16 to the bracket 12. The system 10 further includes an anvil 20 carried by the arm 16 where the arm positions the anvil to be under a driver of the nail gun 14, and the anvil bends nails 22 driven by the driver. The system 10 additionally includes a biasing member 30 to urge the arm 16 towards the bracket 12.

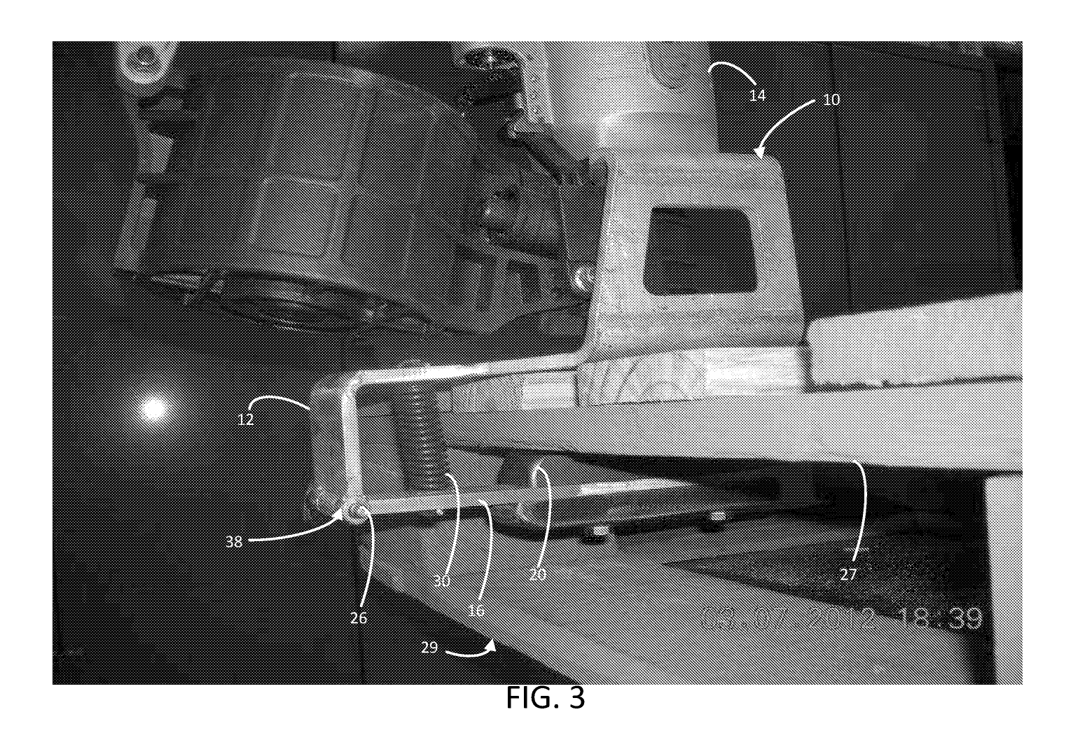

In view of the foregoing, system 10 provides a novel and unobvious nailing system. For example, the system 10 enables clinching nails 22 to be used to secure wood boards during the pallet 29 (see FIG. 3) production/repair process. The use of clinch nails 22 improves the board retention over different kinds of fasteners. The system 10 therefore becomes a practical solution in the repair process of shipping platforms. Before system 10, clinch nails were only achieved in the new pallet manufacturing process.

In one embodiment, the system 10 attaches to the nail gun 14 and comprises of 2 parts. Part 1 is the bracket 12 that bolts into the nail gun's 14 body (by removing and re-installing the existing bolts). Part 2 comprises an anvil 20 attached to a moving arm 16 that slides under the surface being nailed. Part 1 and part 2 are put together by a hinge 38 and secured with a pin 26. The arm 16 also carries at least one biasing members 30, e.g. spring, to produce pressure against the nailing surface. When a nail 22 is fired from the nail gun 14, it goes through the wood 27 and hits the anvil 20 underneath thus causing it to curl up in a “J” shape, an “L” shape, an irregular shape, and/or the like.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a bracket that mounts to a nail gun;
an arm;
a movable joint to connect the arm to the bracket; and
an anvil carried by the arm, the arm positions the anvil to be under a driver of the nail gun, and the anvil to bend nails driven by the driver.

2. The system of claim 1 wherein the movable joint is resiliently deformable and urges the arm towards the bracket.

3. The system of claim 1 wherein the movable joint comprises a hinge.

4. The system of claim 3 wherein movable joint rotates around a pin.

5. The system of claim 1 wherein the anvil includes a shaped strike portion positioned under the driver to aid in bending the nails driven by the nail gun.

6. The system of claim 3 further comprising a first biasing member to urge the arm towards the bracket.

7. The system of claim 1 further comprising a stop that keeps the bracket and the arm in spaced relations.

8. The system of claim 1 wherein the stop is adjustable.

9. The system of claim 1 wherein the anvil includes an eased edge.

10. The system of claim 1 further comprising a lever to move the arm with respect to the bracket via the movable joint.

11. A method comprising:
mounting a bracket carrying an arm to a nail gun; and
positioning an anvil carried by the arm to be under a driver of the nail gun so that the anvil bends nails driven by the driver.

12. The method of claim 11 further comprising using a biasing member to urge the arm towards the bracket.

13. The method of claim 12 further comprising controlling the spacing between the arm and the bracket with a stop.

14. The method of claim 12 further comprising using a lever to adjust the arm with respect to the bracket.

15. The method of claim 11 further comprising including a shaped strike portion on the anvil positioned under the driver to aid in bending the nails driven by the nail gun.

16. The method of claim 11 further comprising removing a pin to separate the arm from the bracket.

17. A system comprising:
a bracket that mounts to a nail gun;
an arm;
a hinge to connect the arm to the bracket;
an anvil carried by the arm, the arm positions the anvil to be under a driver of the nail gun, and the anvil to bend nails driven by the driver; and
a biasing member to urge the arm towards the bracket.

18. The system of claim 17 further comprising a stop that keeps the bracket and the arm in spaced relations.

19. The system of claim 17 wherein the anvil includes an eased edge.

20. The system of claim 17 further comprising a lever to move the arm with respect to the bracket via the hinge.

21. The system of claim 17 wherein the anvil includes a shaped strike portion positioned under the driver to aid in bending the nails driven by the nail gun.
